(19) United States
(12) Patent Application Publication
(10) Pub. No.: US 2008/0043741 A1
(43) Pub. Date: Feb. 21, 2008

(54) NETWORK DEVICE AND METHOD FOR PROCESSING FRAGMENTED PACKET

(75) Inventor: WAN-HSIU KUO, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/565,661

(22) Filed: Dec. 1, 2006

(30) Foreign Application Priority Data
Aug. 18, 2006 (CN) 200610200812.6

(51) Int. Cl. H04L 12/56

(52) U.S. Cl. 370/394; 370/474; 370/463

(57) ABSTRACT

A network device including a receiving module, a packet determining module, a conversion module, a storage module and a processing module is provided. The receiving module is for receiving fragmented packets. The packet determining module is for determining packet types of the fragmented packets, the packet types comprising a special fragmented packet and a normal fragmented packet, and the special fragmented packet comprising a header field. The conversion module is for converting network parameters of the special fragmented packet. The storage module is for storing buffering information of the normal fragmented packet, along with connection information and fragmentation information of the special fragmented packet. The processing module is for processing the normal fragmented packet and the special fragmented packet according to the buffering information, the connection information and the fragmentation information. A method for processing the fragmented packets is also provided.

### BACKGROUND OF THE INVENTION

1. Field of the Invention

The invention generally relates to a network device and method for processing a packet, and more particularly to a network device and method for processing a fragmented packet.

2. Description of Related Art

In a typical network address translation (NAT) system, as a packet passes the network layer, if a packet size is greater than a maximum transmission unit (MTU), the packet is to be fragmented into a plurality of fragmented packets. There are two types of fragmented packets, a special fragmented packet, usually the first packet, with a TCP/UDP header, and a normal fragmented packet, usually the rest packet, without the TCP/UDP header. The TCP/UDP header indicates an internal Internet protocol (IP) address and an internal port number of the packet, with which the special fragmented packet may be successfully transmitted. Due to a fact that the normal fragmented packet lacks the internal IP address and the internal port number, the normal fragmented packet is very likely to be discarded.

To solve the problem raised above, a present solution is to reassemble all the fragmented packets, obtain an internal IP address and an internal port number of a reassembled packet by checking the TCP/UDP header thereof, convert the internal IP address and the internal port number according to the NAT protocol, refragment the reassembled packet into several fragmented packets, and transmit the fragmented packets according to the converted IP address and port number. However, the reassembling and refragmenting process may increase processing time of the fragmented packets, and inevitably decrease operation efficiency of the overall system. Besides, more memory is also needed to process reassembling and refragmenting.

### SUMMARY OF THE INVENTION

A network device is provided. The network device includes a receiving module, a packet determining module, a conversion module, a storage module, and a processing module. The receiving module receives fragmented packets. The packet determining module determines a packet type of each of the fragmented packets, the packet type including a special fragmented packet and a normal fragmented packet, and the special fragmented packet including a header field. The conversion module converts network parameters of the special fragmented packet. The storage module stores buffering information of the normal fragmented packet, along with connection information and fragmentation information of the special fragmented packet. The processing module processes the normal fragmented packet and the special fragmented packet according to the buffering information, the connection information, and the fragmentation information.

A method for processing a fragmented packet is also provided. The method includes steps of: providing a connection table; receiving a plurality of fragmented packets; determining whether a first fragmented packet is a normal fragmented packet or a special fragmented packet; storing buffering information of the first fragmented packet if the first fragmented packet is the normal fragmented packet; sequentially determining whether one of the following fragmented packets is the special fragmented packet; determining whether connection information of the special fragmented packet has been recorded in the connection table if one of the following fragmented packets is the special fragmented packet; storing fragmentation information of the special fragmented packet if the connection information thereof has been recorded in the connection table; and processing the normal fragmented packet according to the connection information and the fragmentation information.

Other advantages and novel features will become more apparent from the following detailed description when taken in conjunction with the accompanying drawings, in which:

### BRIEF DESCRIPTION OF THE DRAWINGS

FIG. 1 is a diagram illustrating an application environment of a network device of an exemplary embodiment of the invention;

FIG. 2 is a diagram of a fragmentation process of another exemplary embodiment of the invention;

FIG. 3 is a block diagram of a network device of a further exemplary embodiment of the invention;

FIG. 4 is a flowchart of a method for processing a fragmented packet of still another exemplary embodiment of the invention;

FIG. 5 is a detailed flowchart of step S416 shown in FIG. 4; and

FIG. 6 is a detailed flowchart of step S420 shown in FIG. 4.

### DETAILED DESCRIPTION OF THE INVENTION

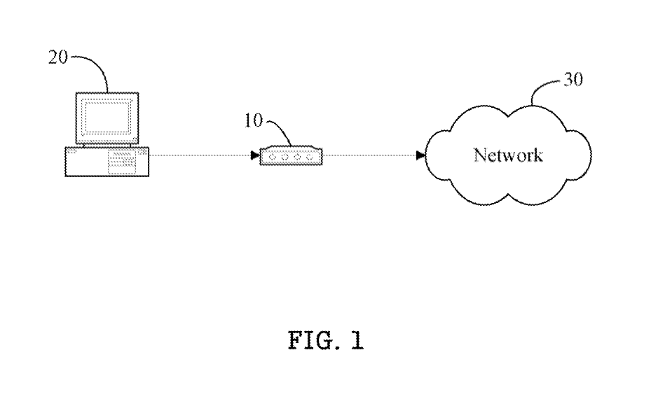

FIG. 1 is a diagram illustrating an application environment of a network device of an exemplary embodiment of the invention.

As shown in FIG. 1, a network device 10 is connected between a client 20 and a network 30, for converting connection information therebetween based on a network address translation (NAT) protocol. In this embodiment, the network device 10 includes a gateway router, the client 20 includes a personal computer (PC), the network 30 includes the Internet, and the connection information includes a port number and an Internet protocol (IP) address.

According to the IP protocol, as a packet transmitted from the client 20 passes the network layer, if a packet size is greater than a maximum transmission unit (MTU), the packet is to be fragmented.

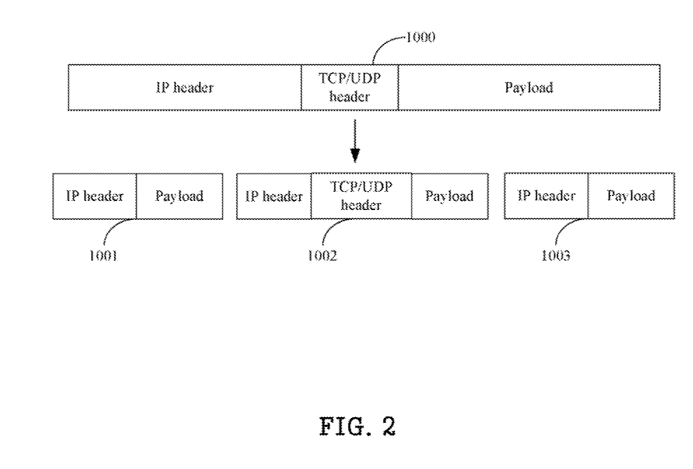

FIG. 2 is a diagram of a fragmentation process of another exemplary embodiment of the invention.

An original packet 1000 is transmitted from the client 20. As shown in FIG. 2, after being fragmented, the original packet 1000 is divided into a first fragmented packet 1001, a second fragmented packet 1002, and a third fragmented packet 1003.

In this embodiment, the first fragmented packet 1001, the second fragmented packet 1002 and the third fragmented packet 1003 all include an IP header field and a payload field, with an exception that the second fragmented packet 1002 further includes a TCP/UDP header field. Herein the second fragmented packet 1002 is referred to as a special fragmented packet comprising complete connection information to transmit the fragmented packets 1001-1003, and the first fragmented packet 1001 and the third fragmented packet 1003 are referred to as normal fragmented packets comprising incomplete connection information which is identically included in the complete connection information. The IP header field indicates an internal IP address and an identification (ID) number of the original packet 1000. The TCP/UDP header indicates an internal IP address and an internal port number of the original packet 1000. For one original packet fragmented into several fragmented packets, there is only one fragmented packet including the TCP/UDP header field. It should be noted that the special fragmented packet is not limited to the second fragmented packet 1002, in other embodiments, the first fragmented packet 1001 or the third fragmented packet 1003 may be the special fragmented packet.

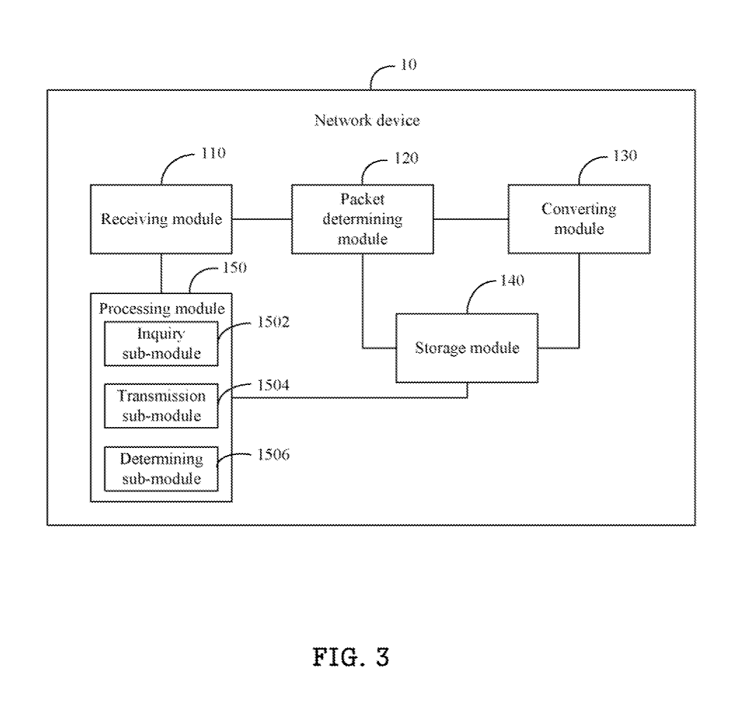

FIG. 3 is a block diagram of the network device 10 of a further exemplary embodiment of the invention.

In this embodiment, the network device 10 includes a receiving module 110, a packet determining module 120, a conversion module 130, a storage module 140, and a processing module 150.

The receiving module 110 receives fragmented packets from the client 20. In this embodiment, the fragmented packets include the first fragmented packet 1001, the second fragmented packet 1002, and the third fragmented packet 1003.

The packet determining module 120 determines a packet type of each of the fragmented packets 1001, 1002, and 1003. In this embodiment, the packet type includes the normal fragmented packet and the special fragmented packet.

In detail, the packet determining module 120 determines the packet type of each of the fragmented packet 1001, 1002, and 1003 by checking a fragment offset (FO) subfield in the IP header field and a more fragments (MF) subfield in a flag field thereof (not shown). If a value indicated by the FO subfield is 0, and a value indicated by the MF subfield is 1, then the fragmented packet is the special fragmented packet. If the value indicated by the FO subfield is 1, the fragmented packet is the normal fragmented packet. In this embodiment, the packet determining module 120 determines that the second fragmented packet 1002 is the special fragmented packet.

The conversion module 130 converts original network parameters of the special fragmented packet. In this embodiment, the original network parameters of the second fragmented packet 1002 include an internal IP address and an internal port number thereof. The conversion module 130 respectively converts an internal IP address and an internal port number into an external IP address and an external port number according to the NAT protocol.

The storage module 140 stores a connection table, a fragmentation table, and a buffering table. In this embodiment, the storage module 140 is a random access memory (RAM).

Table 1 below is the connection table stored in the storage module 140. The connection table records connection information of the special fragmented packet. In this embodiment, the connection information includes the internal IP address and the internal port number, along with the external IP address and the external port number converted by the conversion module 130.

TABLE 1

| Sequence number | Connection information |
|---|---|
| 1 | Internal IP address = 192.168.1.11 |
| | Internal port number = 1000 |
| | External IP address = 220.136.233.167 |
| | External port number = 8080 |
| . . . | . . . |

Table 2 below is the fragmentation table stored in the storage module 140. The fragmentation table records fragmentation information of the special fragmented packet. In this embodiment, the fragmentation information includes the internal IP address, an ID number and an index. The index is a sequence number of the second fragmented packet 1002 in the connection table. For example, since the sequence number of the second fragmented packet 1002 in the connection table is 1, the index is 1.

TABLE 2

| Sequence number | Fragmentation information |
|---|---|
| 1 | Internal IP address = 192.168.1.11 |
| | ID number = 10 |
| | Index = 1 |
| . . . | . . . |

Table 3 below is the buffering table stored in the storage module 140. The buffering table records buffering information of the normal fragmented packet. In this embodiment, the buffering information includes an internal IP address and an ID number of each of the first fragmented packet 1001 and the third fragmented packet 1003.

TABLE 3

| Sequence number | Buffering information |
|---|---|
| 1 | Internal IP address = 192.168.1.11 |
| | ID number = 10 |
| 2 | Internal IP address = 192.168.1.11 |
| | ID number = 10 |
| . . . | . . . |

The processing module 150 processes the normal fragmented packet and the special fragmented packet. In this embodiment, the processing module 150 includes an inquiry sub-module 1502, a transmission sub-module 1504, and a determining sub-module 1506.

The inquiry sub-module 1502 inquiries the buffering table, the fragmentation table and the connection table. In this embodiment, the inquiry sub-module 1502 inquiries the buffering table, the fragmentation table and the connection table, to determine the buffering information of the first fragmented packet 1001 and the third fragmented packet 1003, the sequence number of the second fragmented packet 1002 in the connection table, and the network parameters converted by the conversion module 130, respectively.

The transmission sub-module 1504 transmits the fragmented packets according to converted network parameters. In detail, the transmission sub-module 1504 transmits the first fragmented packet 1001 and the third fragmented packet 1003 according to the external IP address, and transmits the second fragmented packet 1002 according to the external IP address and the external port number.

The determining sub-module 1506 determines whether all the fragmented packets have been transmitted. In this embodiment, the determining sub-module 1506 checks whether a value indicated by the MF subfield in the flag field is 0 or 1. If the value indicated by the MF subfield is 0, a current fragmented packet is the last fragmented packet. If the value in the MF subfield is 1, then a current fragmented packet is not the last fragmented packet.

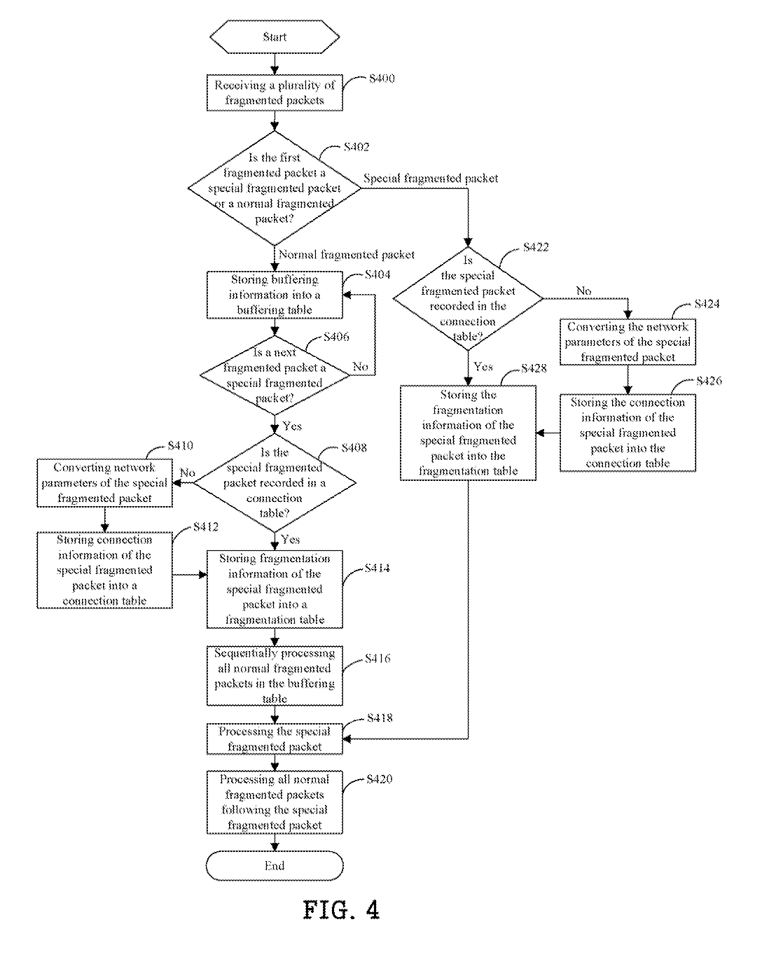

FIG. 4 is a flowchart of a method for processing a fragmented packet of still another exemplary embodiment of the invention.

In step S400, the receiving module 110 receives a plurality of fragmented packets.

In step S402, the packet determining module 120 determines whether the first fragmented packet is the normal fragmented packet or the special fragmented packet. If the first fragmented packet is the normal fragmented packet, the process proceeds to step S404. If the first fragmented packet is the special fragmented packet, the process proceeds to step S422.

In step S404, the storage module 140 stores the buffering information of the normal fragmented packet into the buffering table.

In step S406, the packet determining module 120 determines whether a next fragmented packet is the special fragmented packet. If the next fragmented packet is not the special fragmented packet, the process returns to step S404, otherwise the step proceeds to step S408.

In step S408, the storage module 140 searches the connection table to determine whether the special fragmented packet is already recorded therein. If the special fragmented packet is not recorded therein, the process proceeds to step S410, otherwise the process proceeds to step S414.

In step S410, the conversion module 130 converts original network parameters of the special fragmented packet. In this embodiment, the original network parameters of the special fragmented packet include an internal IP address and an internal port number thereof. The conversion module 130 respectively converts the internal IP address and the internal port number into the external IP address and the external port number according to a network address translation (NAT) protocol.

In step S412, the storage module 140 records the connection information of the special fragmented packet into the connection table. In this embodiment, the connection information includes the original network parameters and the converted network parameters.

In step S414, the storage module 140 records the fragmentation information of the special fragmented packet into the fragmentation table. In this embodiment, the fragmentation information includes the internal IP address, the ID number and the index, the index being a sequence number of the special fragmented packet in the connection table.

In step S416, the processing module 150 sequentially processes all normal fragmented packets in the buffering table.

In step S418, the processing module 150 processes the special fragmented packet. In detail, the processing module 150 transmits the special fragmented packet according to the external IP address and the external port number recorded in the connection table.

In step S420, the processing module 150 processes all normal fragmented packets following the special fragmented packet.

In step S422, the storage module 140 searches the connection table, to determine whether the special fragmented packet is already recorded therein. If the special fragmented packet is not recorded therein, the process proceeds to step S424, otherwise the process proceeds to step S428.

In step S424, the conversion module 130 converts the original network parameters of the special fragmented packet.

In step S426, the storage module 140 records the connection information of the special fragmented packet into the connection table.

In step S428, the storage module 140 records the fragmentation information of the special fragmented packet into the fragmentation table.

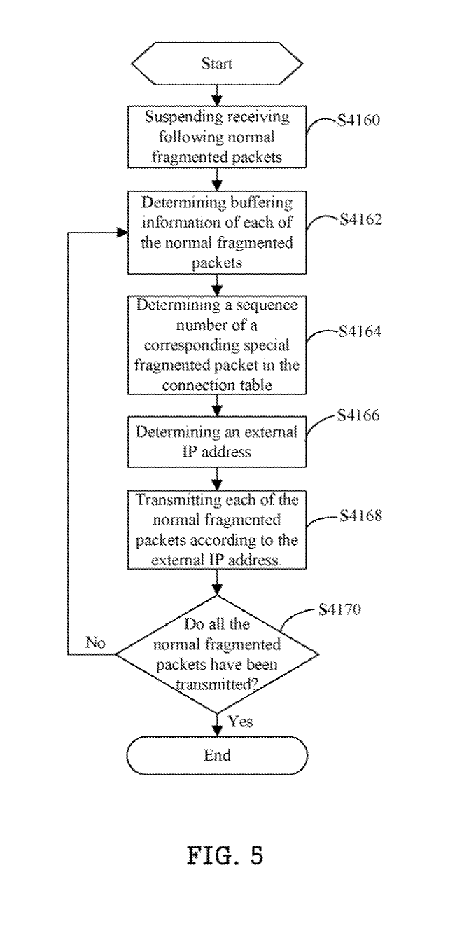

FIG. 5 is a detailed flowchart of step S416 shown in FIG. 4.

In step S4160, the receiving module 110 suspends receiving the following normal fragmented packets.

In step S4162, the inquiry sub-module 1502 inquiries the buffering table to determine buffering information of each of the normal fragmented packets. In this embodiment, the inquiry sub-module 1502 checks the IP header field of each of the normal fragmented packets, to determine the buffering information thereof.

In step S4164, the inquiry sub-module 1502 inquiries the fragmentation table according to the buffering information, to determine a sequence number of a corresponding special fragmented packet in the connection table.

In step S4166, the transmission sub-module 1504 inquiries the connection table according to the sequence number, to determine an external IP address.

In step S4168, the transmission sub-module 1504 transmits each of the normal fragmented packets according to the external IP address.

In step S4170, the determining sub-module 1506 determines whether all the normal fragmented packets have been transmitted. If all the normal fragmented packets have been transmitted, the process proceeds to step S416, otherwise the process returns to step S4140.

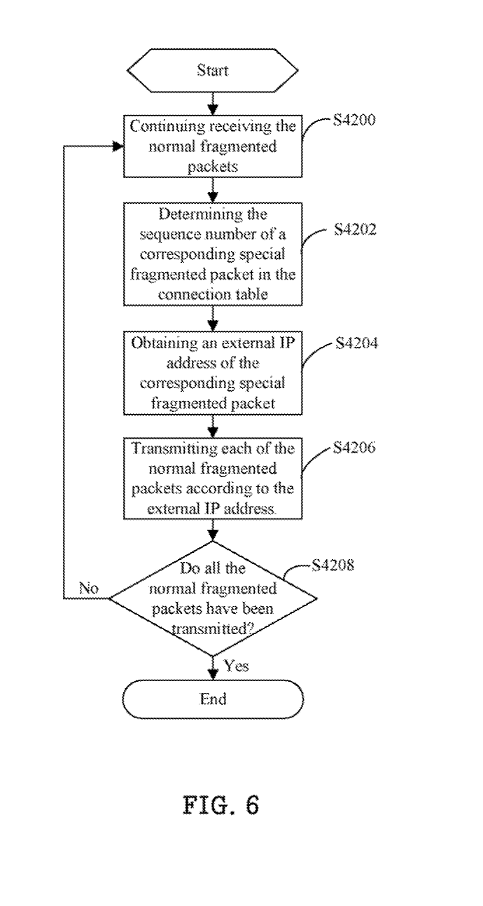

FIG. 6 is a detailed flowchart of step S420 shown in FIG. 4.

In step S4200, the receiving module 110 continues receiving the normal fragmented packets following the special fragmented packet.

In step S4202, the inquiry sub-module 1502 inquiries the fragmentation table according to the buffering information of each of the normal fragmented packets, to determine the sequence number of a corresponding special fragmented packet in the connection table.

In step S4204, the inquiry sub-module 1502 inquires of the connection table according to the sequence number, to obtain an external IP address of the corresponding special fragmented packet.

In step S4206, the transmission sub-module 1504 transmits each of the normal fragmented packets according to the external IP address.

In step S4208, the determining sub-module 1506 determines whether all the normal fragmented packets have been transmitted. If all the normal fragmented packets have been transmitted, the process ends, otherwise the process returns to step S4200.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments.

What is claimed is:

1. A network device, comprising:
a receiving module for receiving a plurality of fragmented packets;
a packet determining module for determining a packet type of each of the fragmented packets, the packet type comprising a special fragmented packet and a normal fragmented packet, and the special fragmented packet comprising a header field;
a conversion module for converting network parameters of the special fragmented packet;
a storage module for storing buffering information of the normal fragmented packet, along with connection information and fragmentation information of the special fragmented packet; and
a processing module for processing the normal fragmented packet and the special fragmented packet according to the buffering information, the connection information, and the fragmentation information.

2. The network device in accordance with claim 1, wherein the storage module comprises a buffering table for recording the buffering information.

3. The network device in accordance with claim 2, wherein the processing module comprises:
an inquiry sub-module for inquiring the buffering table, the fragmentation table, and the connection table;
a transmission sub-module for transmitting the fragmented packets according to converted network parameters; and
a determining sub-module for determining whether all the fragmented packets have been transmitted.

4. The network device in accordance with claim 2, wherein the buffering information of the normal fragmented packet comprises an internal IP address and an identification number thereof.

5. The network device in accordance with claim 1, wherein the storage module further comprises a connection table for recording the connection information.

6. The network device in accordance with claim 5, wherein the inquiry sub-module is further for inquiring the connection table, to determine converted network parameters.

7. The network device in accordance with claim 6, wherein the connection information of the special fragmented packet comprises original network parameters and converted network parameters thereof.

8. The network device in accordance with claim 1, wherein the storage module further comprises a fragmentation table for recording the fragmentation information.

9. The network device in accordance with claim 8, wherein the fragmentation information of the special fragmented packet comprises the internal IP address, the identification number, and an index thereof.

10. The network device in accordance with claim 9, wherein the index is a sequence number of the special fragmented packet in the connection table.

11. The network device in accordance with claim 10, wherein the special fragmented packet comprises a transmission control protocol field or a user datagram protocol field.

12. The network device in accordance with claim 10, wherein the inquiry sub-module is further for inquiring the fragmentation table, to determine the sequence number of the special fragmented packet in the connection table.

13. A method for processing a fragmented packet, comprising steps of:
providing a connection table;
receiving a plurality of fragmented packets;
determining whether a first fragmented packet is a normal fragmented packet or a special fragmented packet;
storing buffering information of the first fragmented packet if the first fragmented packet is the normal fragmented packet;
sequentially determining whether one of the following fragmented packets is the special fragmented packet;
determining whether connection information of the special fragmented packet has been recorded in the connection table if one of the following fragmented packets is the special fragmented packet;
storing fragmentation information of the special fragmented packet if the connection information thereof has been recorded in the connection table; and
processing the normal fragmented packet according to the connection information and the fragmentation information.

14. The method in accordance with claim 13, wherein the connection information of the special fragmented packet comprises original network parameters and converted network parameters thereof.

15. The method in accordance with claim 13, wherein the fragmentation information is stored in a fragmentation table.

16. The method in accordance with claim 13, wherein the step of processing the normal fragmented packet according to the connection information and the fragmentation information comprises steps of:
suspending receiving the following normal fragmented packets;
inquiring of the buffering table to determine buffering information of the normal fragmented packet;
inquiring of the fragmentation table according to the buffering information of the normal fragmented packet, to determine a sequence number of a corresponding special fragmented packet in the connection table;
inquiring of the connection table according to the sequence number, to determine the converted network parameters;
transmitting the normal fragmented packet according to the converted network parameters; and
determining whether all the normal fragmented packets in the buffering table have been transmitted.

17. The method in accordance with claim 13, further comprising steps of:
transmitting the special fragmented packet according to the connection information; and
processing normal fragmented packets following the special fragmented packet according to the connection information and the fragmentation information.

18. The method in accordance with claim 17, wherein the step of processing normal fragmented packets following the special fragmented packet according to the connection information and the fragmentation information comprises steps of:
continuing receiving the normal fragmented packets following the special fragmented packet;
inquiring of the fragmentation table according to the buffering information of the following normal fragmented packets, to determine sequence numbers of a corresponding special fragmented packet in the connection table;
inquiring of the connection table according to the sequence numbers of the following normal fragmented packets, to determine the converted network parameters thereof;
transmitting the normal fragmented packets according to the converted network parameters; and
determining whether all the normal fragmented packets have been transmitted.

19. The method in accordance with claim 13, further comprising steps of:
inquiring of the connection table to determine whether the special fragmented packet is recorded therein if the first fragmented packet is the special fragmented packet;
converting the network parameters of the special fragmented packet if the special fragmented packet is recorded in the connection table;
recording the connection information of the special fragmented packet in the connection table; and
recording the fragmentation information of the special fragmented packet in the fragmentation table.

20. A method for processing fragmented packets in a network device, comprising steps of:
receiving a fragmented packet in a network device;
determining whether said received fragmented packet is a normal fragmented packet comprising incomplete connection information for transmission thereof or a special fragmented packet comprising complete connection information for transmission thereof;
determining whether said complete connection information of said special fragmented packet has been recorded in said network device when said received fragmented packet is determined as said special fragmented packet;
providing fragmentation information in said network device according to said complete connection information of said special fragmented packet; and
processing any received fragmented packet determined as said normal fragmented packet according to said incomplete connection information and said fragmentation information when said incomplete connection information is identically included in said complete connection information of said special fragmented packet.
